(19) United States
(12) Patent Application Publication
(10) Pub. No.: US 2025/0375833 A1
(43) Pub. Date: Dec. 11, 2025

(54) METHOD OF MANUFACTURING WELDED MEMBER

(71) Applicant: FUTABA INDUSTRIAL CO., LTD., Okazaki-shi (JP)

(72) Inventor: Yusuke OSHIMA, Okazaki-shi (JP)

(21) Appl. No.: 19/219,166

(22) Filed: May 27, 2025

(30) Foreign Application Priority Data
Jun. 10, 2024 (JP) 2024-093755

(51) Int. Cl. B23K 26/22

(52) U.S. Cl. CPC B23K 26/22

(57) ABSTRACT

A method of manufacturing a welded member, the method including welding end surfaces of a thick plate and a thin plate to each other by laser beams. Irradiation regions irradiated with the laser beams includes a first and a second region. A corner portion of the thick plate is heated to melt by the laser beams via the first region that passes through at least a vicinity of the end surface of the thick plate. The end surfaces are welded to each other by the laser beams via the second region that passes through a vicinity of the corner portion, which has melted by the laser beams via the first region, and a vicinity of the end surface of the thin plate. An amount of heat applied to the thick plate via the first region is greater than that applied to the thin plate via the first region.

### CROSS-REFERENCE TO RELATED APPLICATIONS

This application claims the benefit of Japanese Patent Application No. 2024-093755 filed on June 10, 2024 with the Japan Patent Office, the entire disclosure of which is incorporated herein by reference.

### BACKGROUND

The present disclosure relates to a method of manufacturing a welded member formed by welding.

A technique has been known in which end surfaces of plate materials having different thicknesses are butted against and welded to each other. In a technique disclosed in Japanese Unexamined Patent Application Publication No. H06-254689, an end surface of a thin plate and an end surface of a thick plate are joined to each other by performing laser welding in which the end surfaces are butted against each other, and then a laser beam is radiated at the thin plate in such a manner that the laser beam penetrates the thin plate in its thickness directions. Subsequently, metal inert gas welding is performed targeting a corner portion of the welded end surface of the thick plate to thereby cover a joined portion obtained through the laser welding with metal melted by the metal inert gas welding.

However, in a case where both laser welding and metal inert gas welding are performed as in the method disclosed in Japanese Unexamined Patent Application Publication No. H06-254689, equipment is required for each welding method, which results in increased costs including production costs and equipment costs. In order to reduce the costs, it is desired to perform welding by only laser welding.

On the other hand, in a case where welding is performed by only laser welding, if an output of the laser beam is adjusted to prevent the thin plate from melting down, an amount of heat applied to the thick plate may be insufficient. As a result, it may be impossible to melt the corner portion of the end surface of the thick plate, and consequently it may be impossible to make the joined portion obtained through the welding have a smooth shape.

### SUMMARY

In one mode of the present disclosure, it is desired to make a joined portion obtained through welding have a smooth shape in laser welding.

One mode of the present disclosure is a method of manufacturing a welded member. The method comprises welding an end surface of a thick plate and an end surface of a thin plate to each other to form the welded member by radiating laser beams at the thick plate and the thin plate in a state where the end surface of the thick plate and the end surface of the thin plate are butted against each other. The thick plate is a plate-shaped member. The thin plate is a plate-shaped member that has a thickness smaller than a thickness of the thick plate. Irradiation regions that are irradiated with the laser beams are displaced from a start point toward an end point on an irradiation path that extends along the end surface of the thick plate and the end surface of the thin plate. The irradiation regions include a first region and a second region. A corner portion that is an end portion of the end surface of the thick plate in thickness directions of the thick plate is heated to melt by the first region passing through at least a vicinity of the end surface of the thick plate. The end surface of the thick plate and the end surface of the thin plate are welded to each other by the second region passing through a vicinity of the corner portion of the thick plate, which has melted by the first region passing through at least the vicinity of the end surface of the thick plate, and a vicinity of the end surface of the thin plate. An amount of heat applied to the thick plate via the first region is greater than an amount of heat applied to the thin plate via the first region.

In the above-described configuration, it is possible to melt the corner portion of the end surface of the thick plate in the welding. Therefore, it is possible to make a joined portion obtained through the welding to have a smooth shape.

In one mode of the present disclosure, the first region and the second region may be positioned away from each other.

In the above-described configuration, it is possible to perform the welding effectively.

In one mode of the present disclosure, the first region may be displaced on the irradiation path in a state where the first region is positioned across the thick plate and the thin plate.

In the above-described configuration, the thin plate is heated while the corner portion of the thick plate is being melted, and thus it is possible to prevent a molten material from cooling down to solidify on the thin plate when the molten material flows toward the thin plate. Therefore, it is possible to make the joined portion obtained through the welding have a smooth shape.

In one mode of the present disclosure, the laser beams may be formed by splitting a single laser beam generated by a single light source.

In the above-described configuration, it is possible to form the irradiation regions by the single light source. Therefore, it is possible to reduce equipment costs for the welding.

In one mode of the present disclosure, the laser beams may be formed by splitting the single laser beam using a DOE (Diffractive Optical Element).

In the above-described configuration, it is possible to form the laser beams effectively.

In one mode of the present disclosure, the first region may include a primary region and a subsidiary region. The subsidiary region is positioned in the irradiation path on a side closer to the start point with respect to the primary region and is positioned so as not to overlap the primary region. A portion, including the corner portion, of the thick plate in the vicinity of the end surface of the thick plate may be heated to melt by the primary region passing through at least the vicinity of the end surface of the thick plate. A portion of the thick plate in a vicinity of a boundary between a region through which the primary region does not pass and a region through which the primary region has passed may be heated to melt by the subsidiary region passing through the portion of the thick plate in the vicinity of the boundary.

In the above-described configuration, it is possible to make the portion of the thick plate in the vicinity of the boundary between the region through which the primary region does not pass and the region through which the primary region has passed have a smooth shape.

In one mode of the present disclosure, each of the primary region and the subsidiary region may be a circular region.

In the above-described configuration, it is possible to make the portion of the thick plate in the vicinity of the boundary between the region through which the primary region does not pass and the region through which the primary region has passed have a smooth shape.

In one mode of the present disclosure, the second region may include a preliminary region and a main region. The thick plate and the thin plate may be heated by the preliminary region passing through the thick plate and the thin plate. The end surface of the thick plate and the end surface of the thin plate are welded to each other by the main region passing within a region through which the preliminary region has passed in the thick plate and the thin plate. A power density of the main region may be higher than a power density of the preliminary region.

In the above-described configuration, it is possible to pre-heat portions of the thick plate and the thin plate through which the main region is going to pass by the preliminary region passing through the portions.

In one mode of the present disclosure, the main region may be a circular region, and the preliminary region may be an annular region that surrounds the main region.

In the above-described configuration, it is possible to effectively pre-heat the portions of the thick plate and the thin plate through which the main region is going to pass by the preliminary region passing through the portions.

In one mode of the present disclosure, each of the thick plate and the thin plate may be a zinc-coated steel plate.

In the above-described configuration, it is possible to make the joined portion obtained through welding to have a smooth shape in welding of the two zinc-coated steel plates.

### BRIEF DESCRIPTION OF THE DRAWINGS

An example embodiment of the present disclosure will be described hereinafter with reference to the accompanying drawings, in which:

FIG. 1 is an explanatory view in which a thick plate and a thin plate are viewed from above;

FIG. 2 is an explanatory view of a laser device;

FIG. 3 is an explanatory view showing the thick plate melted by laser beams via a first region;

FIG. 4 is an explanatory view showing the thick plate and the thin plate welded to each other by the laser beams via a second region;

FIG. 5 is an explanatory view showing positions of a first region and a second region in another embodiment;

FIG. 6A is an explanatory view showing shapes of a first region and a second region in still another embodiment;

FIG. 6B is an explanatory view showing shapes of a first region and a second region in still another embodiment;

FIG. 6C is an explanatory view showing shapes of a first region and a second region in still another embodiment;

FIG. 6D is an explanatory view showing shapes of a first region and a second region in still another embodiment;

FIG. 7 is an explanatory view showing positions of a primary region and a subsidiary region in still another embodiment; and

FIG. 8 is an explanatory view showing positions of a preliminary region and a main region in still another embodiment.

### DETAILED DESCRIPTION OF EXEMPLARY EMBODIMENTS

### 1. First Embodiment

### 1-1. Overview

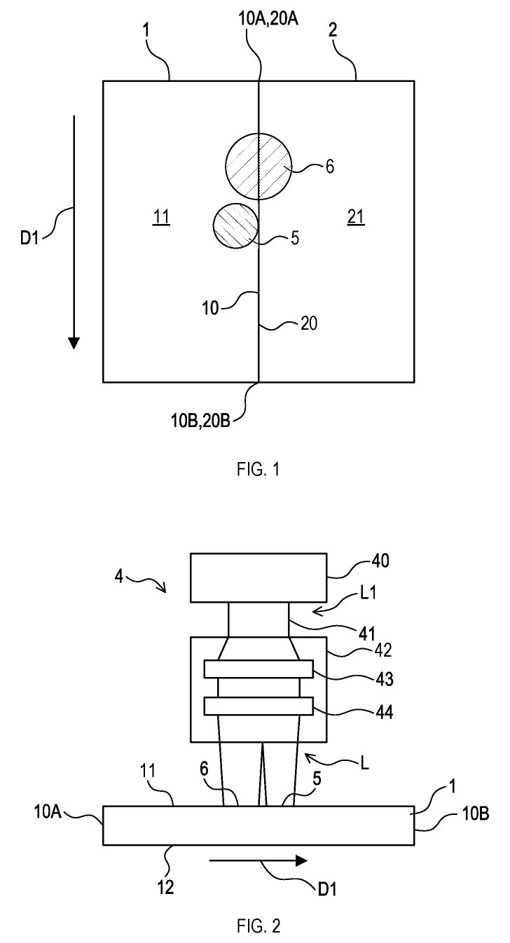

In the present embodiment, a welded member 3 is manufactured by welding a thick plate 1 and a thin plate 2, which are plate-shaped members, to each other using a laser device 4 (see, FIGS. 1 to 4). In one example, each of the thick plate 1 and the thin plate 2 is a zinc-coated steel plate and has a planar rectangular shape. However, without being limited thereto, the thick plate 1 and the thin plate 2 may be made of a steel material other than a stainless steel or may include metal other than a steel material. Shapes of the thick plate 1 and the thin plate 2 are appropriately determined.

A plate thickness of the thin plate 2 is smaller than a plate thickness of the thick plate 1. In one example, the plate thickness of the thick plate 1 is 1.0 mm and the plate thickness of the thin plate 2 is 0.6 mm. However, without being limited thereto, a combination of the plate thicknesses of the thick plate 1 and the thin plate 2 may be, for example, such that the plate thickness of the thick plate 1 is 1.6 mm, and the plate thickness of the thin plate 2 is 1.4 mm. Furthermore, a combination of the plate thicknesses of the thick plate 1 and the thin plate 2 may be, for example, such that the plate thickness of the thick plate 1 is 1.8 mm, and the plate thickness of the thin plate 2 is 0.6 mm.

### 1-2. Laser Device

The laser device 4 comprises a laser oscillator 40, a light path 41, and a head 42. The laser device 4 is configured to radiate laser beams L at the thick plate 1 and the thin plate 2 from the head 42 (see, FIG. 2).

The laser oscillator 40 generates a single laser beam L1 by exciting a laser medium and amplifying a light emitted by the excited laser medium. In one example, the laser oscillator 40 may be configured as a fiber laser using an optical fiber as an amplification medium.

The light path 41 guides the single laser beam L1 generated by the laser oscillator 40 to the head 42.

The head 42 comprises a DOE (Diffractive Optical Element) 43 and a focus lens 44.

The DOE 43 splits the single laser beam L1 that has passed through the light path 41. The laser beams L that have been split through the DOE 43 are radiated from the head 42.

The focus lens 44 is a part of the laser device 4 for adjusting a focus of the laser beams L. In the welding, the focus of the laser beams L is adjusted in such a manner that the laser beams L converge just before the thick plate 1 and the thin plate 2.

It should be noted that, without being limited to the above-described method, the laser beams L may be formed by various methods. Specifically, for example, the laser beams L may be formed by a splitting mirror instead of the DOE 43. Furthermore, for example, the laser beams L may be formed by a PLC splitter, which splits a single optical fiber into a plurality of optical fibers, instead of the DOE 43.

### 1-3. Method of Manufacturing Welded Member

A method of manufacturing the welded member 3 comprises: an arrangement step in which an end surface 10 that forms one side surface of the thick plate 1 and an end surface 20 that forms one side surface of the thin plate 2 are arranged to butt against each other; and a welding step in which the thick plate 1 and the thin plate 2 are welded to each other using the laser device 4 to form the welded member 3.

### (1) Arrangement Step

Firstly, in the arrangement step, the thick plate 1 and the thin plate 2 are arranged on a worktable in such a manner that the thick plate 1 and the thin plate 2 extend in horizontal directions and that the end surface 10 of the thick plate 1 and the end surface 20 of the thin plate 2 are butted against each other (see, FIG. 1). In the thick plate 1 arranged on the worktable, a surface located on an upper side is referred to as a first surface 11, and a surface located on a side opposite to the first surface 11 is referred to as a second surface 12. In the thin plate 2 arranged on the worktable, a surface located on an upper side is referred to as a first surface 21, and a surface located on a side opposite to the first surface 21 is referred to as a second surface 22. An end portion of the end surface 10 adjacent to the first surface 11 is referred to as a corner portion 13. An end portion of the end surface 20 adjacent to the first surface 21 is referred to as a corner portion 23. Since the plate thickness of the thin plate 2 is smaller than the plate thickness of the thick plate 1, a step is formed between the first surface 11 and the first surface 21.

### (2) Welding Step

Next, in the welding step, the laser beams L are radiated at the thick plate 1 and the thin plate 2 arranged on the worktable in the arrangement step (see, FIG. 1). Specifically, the laser beams L are radiated at the vicinity of the end surface 10 in the first surface 11 of the thick plate 1 and the end surface 20 in the first surface 21 of the thin plate 2 from the head 42 of the laser device 4.

The laser device 4 displaces the head 42 to thereby displace irradiation regions, which are irradiated with the laser beams L, in a first direction D1 from a first end 10A to a second end 10B of the end surface 10 along the end surface 10 and from a first end 20A to a second end 20B of the end surface 20 along the end surface 20. It should be noted that, without being limited thereto, for example, the irradiation regions may be displaced by moving the worktable to displace positions of the thick plate 1 and the thin plate 2 instead of by displacing the head 42. Hereinafter, a path in which the irradiation regions are displaced along the end surfaces 10, 20 is referred to as an irradiation path.

The irradiation regions include a first region 5 and a second region 6. The first region 5 and the second region 6 are formed by the laser beams L.

The first region 5 is a circular region positioned in the vicinity of the end surface 10 in the first surface 11 of the thick plate 1. In one example, the first region 5 overlaps a ridge line 14 that is a boundary between the end surface 10 and the first surface 11 of the thick plate 1. However, without being limited thereto, the first region 5 does not necessarily have to overlap the ridge line 14. In the present embodiment, the first region 5 does not overlap the thin plate 2. Therefore, an amount of heat applied to the thick plate 1 via the first region 5 is greater than an amount of heat applied to the thin plate 2 via the first region 5.

The second region 6 is a circular region positioned across the first surface 11 of the thick plate 1 and the first surface 21 of the thin plate 2. The first region 5 and the second region 6 are positioned away from each other. In other words, the first region 5 does not overlap the second region 6, and the first region 5 does not contact the second region 6. The second region 6 is positioned in the irradiation path on a side closer to the first end 10A, 20A with respect to the first region 5.

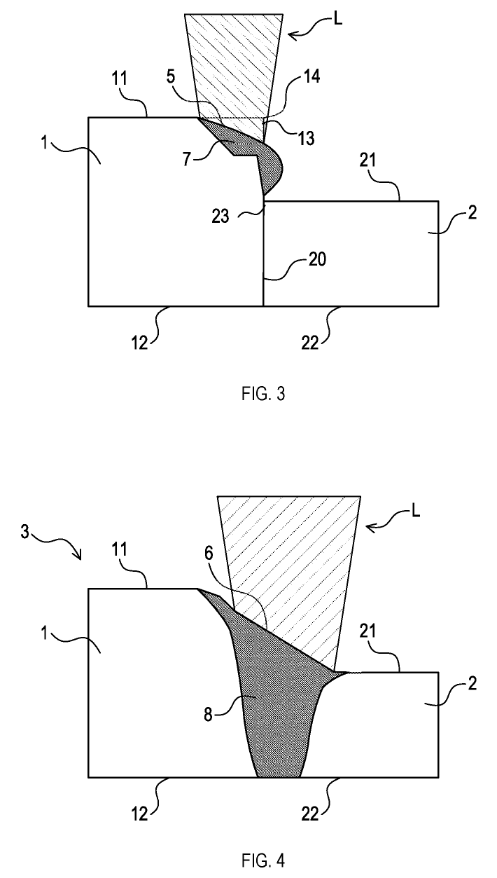

In the welding step, the first region 5 passes through the vicinity of the end surface 10 in the first surface 11 of the thick plate 1 in the first direction D1 along the end surface 10. As a result, the corner portion 13 of the thick plate 1 is heated to melt (see, FIG. 3). A molten metal 7, which is a molten material, flows toward the thin plate 2.

Next, the second region 6 passes through the vicinity of the corner portion 13 of the thick plate 1, which has melted by the first region 5 passing through the vicinity of the end surface 10 in the first surface 11 of the thick plate 1, and the vicinity of the end surface 20 of the thin plate 2 in the first direction D1 along the end surfaces 10, 20. As a result, a material in the vicinity of the end surfaces 10, 20 is heated to melt. Then, the temperature of the molten material decreases so that the molten material solidifies, and consequently a joined portion 8 is formed (see, FIG. 4). In this way, the thick plate 1 and the thin plate 2 are welded to each other to form the welded member 3.

### 1-4. Effects

(1) In the above-described embodiment, in welding of the thick plate 1 and the thin plate 2 to form the welded member 3, it is possible to melt the corner portion 13 by the laser beams L heating the thick plate 1 via the first region 5. Therefore, it is possible to make the joined portion 8 to have a smooth shape.

(2) Since the first region 5 overlaps the thick plate 1 but does not overlap the thin plate 2, the amount of heat applied to the thick plate 1 via the first region 5 is greater than the amount of heat applied to the thin plate 2 via the first region 5. Therefore, it is possible to prevent the thin plate 2 from being overheated to melt down by the laser beams L via the first region 5 while the corner portion 13 is heated to melt by the laser beams L via the first region 5.

(3) The first region 5 and the second region 6 are formed by the laser beams L. The laser beams L are formed by splitting the single laser beam L1 generated by the single laser oscillator 40. That is, it is not necessary to use a plurality of laser oscillators to form the first region 5 and the second region 6. Therefore, it is possible to reduce equipment costs for the welding.

### 1-5. Correspondence Relationship between Terms

In the above-described embodiment, the laser oscillator 40 corresponds to one example of a light source. The first end 10A, 20A corresponds to one example of a start point, and the second end 10B, 20B corresponds to one example of an end point.

### 2. Other Embodiments

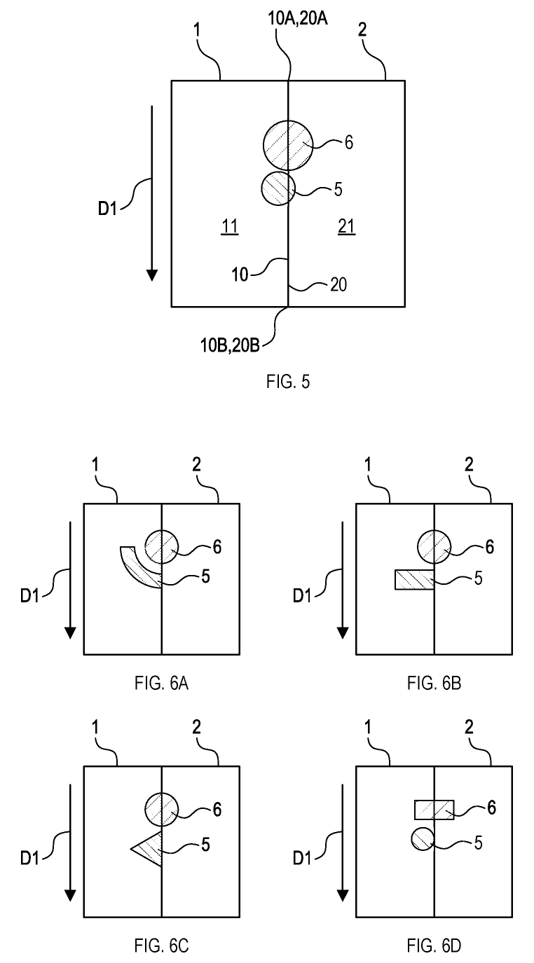

(1) In the above-described embodiment, the first region 5 overlaps the thick plate 1 but does not overlap the thin plate 2. However, the first region 5 may be positioned to overlap both the thick plate 1 and the thin plate 2 (see, FIG. 5). In such a configuration, it is possible to heat the first surface 21 of the thin plate 2, which is adjacent to the corner portion 13 of the thick plate 1, while the corner portion 13 is heated to melt by the laser beams L via the first region 5. Thus, it is possible to prevent the temperature of the molten metal 7 from decreasing, and consequently, the molten metal 7 from solidifying when the molten metal 7 flows from the thick plate 1 toward the thin plate 2. Therefore, it is possible to make the joined portion 8 have a smooth shape.

(2) In the above-described embodiment, both the first region 5 and the second region 6 are circular regions. However, shapes of the first region 5 and the second region 6 are not limited to circles. For example, the first region 5 may have an elongated shape extending in an arc shape (see, FIG. 6A), may have a rectangular shape (see, FIG. 6B), or may have a triangular shape (see, FIG. 6C). Furthermore, for example, the second region 6 may have a rectangular shape (see, FIG. 6D).

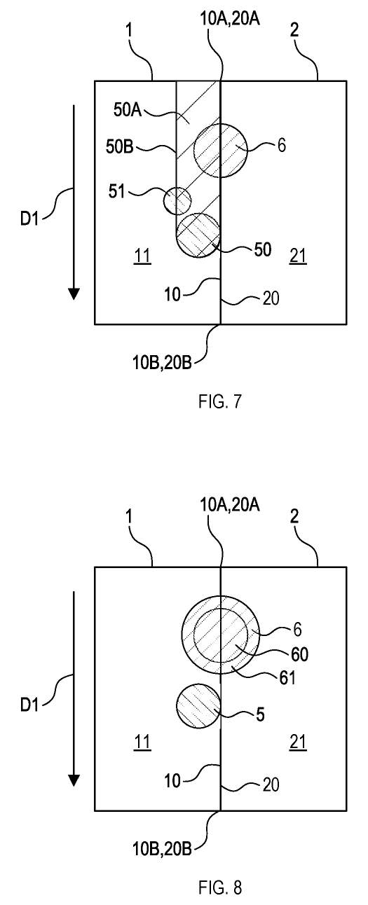

(3) In the above-described embodiment, the first region 5 is a single region. However, without being limited thereto, for example, the first region 5 may include a primary region 50 and a subsidiary region 51 (see, FIG. 7).

The primary region 50 is a circular region positioned in the vicinity of the end surface 10 in the first surface 11 of the thick plate 1. The primary region 50 passes through the vicinity of the end surface 10 in the first surface 11 of the thick plate 1 in the first direction D1 along the end surface 10. As a result, the portion, including the corner portion 13, of the thick plate 1 in the vicinity of the end surface 10 of the thick plate 1 is heated to melt. A region through which the primary region 50 has passed in the first surface 11 of the thick plate 1 is referred to as a passed region 50A. A boundary between a region through which the primary region 50 does not pass and the passed region 50A in the first surface 11 of the thick plate 1 is referred to as a boundary portion 50B.

The subsidiary region 51 is a circular region positioned in the irradiation path on a side closer to the first end 10A with respect to the primary region 50. The subsidiary region 51 does not overlap the primary region 50. The subsidiary region 51 is positioned to overlap the boundary portion 50B. The subsidiary region 51 passes through a portion of the thick plate 1 in the vicinity of the boundary portion 50B in the first direction D1 along the end surface 10. As a result, the portion of the thick plate 1 in the vicinity of the boundary portion 50B is heated to melt.

In such a configuration, in a case in which a difference between the plate thickness of the thick plate 1 and the plate thickness of the thin plate 2 is large, angular portions may be formed in the vicinity of the boundary portion 50B by material of the thick plate 1 in the passed region 50A being melt by the laser beams L via the primary region 50, and then flowing toward the thin plate 2. However, it is possible to melt the angular portions by the laser beams L via the subsidiary region 51, and thus it is possible to make the vicinity of the boundary portion 50B have a smooth shape.

(4) In the above-described embodiment, the second region 6 is a single region. However, without being limited thereto, for example, the second region 6 may include a main region 60 and a preliminary region 61 (see, FIG. 8).

The main region 60 is a circular region positioned across the first surface 11 of the thick plate 1 and the first surface 21 of the thin plate 2. The main region 60 passes within a region through which the preliminary region 61 has passed in the thick plate 1 and the thin plate 2 in the first direction D1 along the end surfaces 10, 20. As a result, material in the vicinity of the end surfaces 10, 20 is heated to melt. Then the molten material solidifies, and consequently the joined portion 8 is formed.

The preliminary region 61 is an annular region positioned to surround the main region 60. It should be noted that, without being limited thereto, the preliminary region 61 may be, for example, a region positioned in the irradiation path on a side closer to the second end 10B, 20B with respect to the main region 60 instead of surrounding the main region 60.

The preliminary region 61 passes through the vicinity of the end surface 10 of the thick plate 1 and the end surface 20 of the thin plate 2 in the first direction D1 along the end surfaces 10, 20. As a result, a region through which the main region 60 is going to pass in the thick plate 1 and the thin plate 2 is pre-heated in the preliminary region 61. It should be noted that a power density of the main region 60 is higher than a power density of the preliminary region 61. The term “power density” as used herein indicates an output of a laser beam per unit area of each region. In one example, the unit for power density is W/cm².

In such a configuration, it is possible to pre-heat the region through which the main region 60 is going to pass by the preliminary region passing through the region in welding of the thick plate 1 and the thin plate 2 by the laser beams L via the main region 60. Therefore, it is possible to reduce sudden temperature rise in the welding to thereby reduce generation of spatters.

(5) Two or more functions performed by one element in the above-described embodiments may be achieved by two or more elements. One function performed by one element may be achieved by two or more elements. Two or more functions performed by two or more elements may be achieved by one element. One function performed by two or more elements may be achieved by one element. Furthermore, a part of the configuration in the above-described embodiments may be omitted. Still further, at least a part of the configuration in the above-described embodiments may be added to or replaced with another part of the configuration in the above-described embodiments.

### 3. Technical Ideas Disclosed Herein

### Item 1

A method of manufacturing a welded member, the method comprising:

welding an end surface of a thick plate and an end surface of a thin plate to each other to form the welded member by radiating laser beams at the thick plate and the thin plate in a state where the end surface of the thick plate and the end surface of the thin plate are butted against each other, the thick plate being a plate-shaped member, the thin plate being a plate-shaped member that has a thickness smaller than a thickness of the thick plate,

irradiation regions that are irradiated with the laser beams being displaced from a start point toward an end point on an irradiation path that extends along the end surface of the thick plate and the end surface of the thin plate,

the irradiation regions including a first region and a second region,

a corner portion that is an end portion of the end surface of the thick plate in thickness directions of the thick plate being heated to melt by the first region passing through at least a vicinity of the end surface of the thick plate,

the end surface of the thick plate and the end surface of the thin plate being welded to each other by the second region passing through a vicinity of the corner portion of the thick plate, which has melted by the first region passing through at least the vicinity of the end surface of the thick plate, and a vicinity of the end surface of the thin plate, and

an amount of heat applied to the thick plate via the first region being greater than an amount of heat applied to the thin plate via the first region.

### Item 2

The method of manufacturing a welded member according to item 1,

wherein the first region and the second region are positioned away from each other.

### Item 3

The method of manufacturing a welded member according to item 1 or 2,

wherein the first region is displaced on the irradiation path in a state where the first region is positioned across the thick plate and the thin plate.

### Item 4

The method of manufacturing a welded member according to any one of items 1 to 3,

wherein the laser beams are formed by splitting a single laser beam generated by a single light source.

### Item 5

The method of manufacturing a welded member according to item 4,

wherein the laser beams are formed by splitting the single laser beam using a DOE (Diffractive Optical Element).

### Item 6

The method of manufacturing a welded member according to any one of items 1 to 5,

wherein the first region includes:

a primary region; and

a subsidiary region that is positioned in the irradiation path on a side closer to the start point with respect to the primary region and that is positioned so as not to overlap the primary region,

wherein a portion, including the corner portion, of the thick plate in the vicinity of the end surface of the thick plate is heated to melt by the primary region passing through at least the vicinity of the end surface of the thick plate, and

wherein a portion of the thick plate in a vicinity of a boundary between a region through which the primary region does not pass and a region through which the primary region has passed is heated to melt by the subsidiary region passing through the portion of the thick plate in the vicinity of the boundary.

### Item 7

The method of manufacturing a welded member according to item 6,

wherein each of the primary region and the subsidiary region is a circular region.

### Item 8

The method of manufacturing a welded member according to any one of items 1 to 7,

wherein the second region includes a preliminary region and a main region,

wherein the thick plate and the thin plate are heated by the preliminary region passing through the thick plate and the thin plate,

wherein the end surface of the thick plate and the end surface of the thin plate are welded to each other by the main region passing within a region through which the preliminary region has passed in the thick plate and the thin plate, and

wherein a power density of the main region is higher than a power density of the preliminary region.

### Item 9

The method of manufacturing a welded member according to item 8,

wherein the main region is a circular region, and

wherein the preliminary region is an annular region that surrounds the main region.

### Item 10

The method of manufacturing a welded member according to any one of items 1 to 9,

wherein each of the thick plate and the thin plate is a zinc-coated steel plate.

1. A method of manufacturing a welded member, the method comprising:
welding an end surface of a thick plate and an end surface of a thin plate to each other to form the welded member by radiating laser beams at the thick plate and the thin plate in a state where the end surface of the thick plate and the end surface of the thin plate are butted against each other, the thick plate being a plate-shaped member, the thin plate being a plate-shaped member that has a thickness smaller than a thickness of the thick plate,
irradiation regions that are irradiated with the laser beams being displaced from a start point toward an end point on an irradiation path that extends along the end surface of the thick plate and the end surface of the thin plate,
the irradiation regions including a first region and a second region,
a corner portion that is an end portion of the end surface of the thick plate in thickness directions of the thick plate being heated to melt by the first region passing through at least a vicinity of the end surface of the thick plate,
the end surface of the thick plate and the end surface of the thin plate being welded to each other by the second region passing through a vicinity of the corner portion of the thick plate, which has melted by the first region passing through at least the vicinity of the end surface of the thick plate, and a vicinity of the end surface of the thin plate, and an amount of heat applied to the thick plate via the first region being greater than an amount of heat applied to the thin plate via the first region.

2. The method of manufacturing a welded member according to claim 1,
wherein the first region and the second region are positioned away from each other.

3. The method of manufacturing a welded member according to claim 1,
wherein the first region is displaced on the irradiation path in a state where the
first region is positioned across the thick plate and the thin plate.

4. The method of manufacturing a welded member according to claim 1,
wherein the laser beams are formed by splitting a single laser beam generated by a single light source.

5. The method of manufacturing a welded member according to claim 4,
wherein the laser beams are formed by splitting the single laser beam using a DOE (Diffractive Optical Element).

6. The method of manufacturing a welded member according to claim 1,
wherein the first region includes:
a primary region; and
a subsidiary region that is positioned in the irradiation path on a side closer to the start point with respect to the primary region and that is positioned so as not to overlap the primary region,
wherein a portion, including the corner portion, of the thick plate in the vicinity of the end surface of the thick plate is heated to melt by the primary region passing through at least the vicinity of the end surface of the thick plate, and
wherein a portion of the thick plate in a vicinity of a boundary between a region through which the primary region does not pass and a region through which the primary region has passed is heated to melt by the subsidiary region passing through the portion of the thick plate in the vicinity of the boundary.

7. The method of manufacturing a welded member according to claim 6,
wherein each of the primary region and the subsidiary region is a circular region.

8. The method of manufacturing a welded member according to claim 1,
wherein the second region includes a preliminary region and a main region,
wherein the thick plate and the thin plate are heated by the preliminary region
passing through the thick plate and the thin plate, wherein the end surface of the thick plate and the end surface of the thin plate are welded to each other by the main region passing within a region through which the preliminary region has passed in the thick plate and the thin plate, and wherein a power density of the main region is higher than a power density of the preliminary region.

9. The method of manufacturing a welded member according to claim 8,
wherein the main region is a circular region, and
wherein the preliminary region is an annular region that surrounds the main region.

10. The method of manufacturing a welded member according to claim 1,
wherein each of the thick plate and the thin plate is a zinc-coated steel plate.
